(19) United States
(12) Patent Application Publication
(10) Pub. No.: US 2006/0164408 A1
(43) Pub. Date: Jul. 27, 2006

(54) Display device

(75) Inventors: Ryuji Nishikawa, Gifu-shi (JP); Takashi Ogawa, Anpachi-gun (JP)

Correspondence Address: MORRISON & FOERSTER LLP, 1650 TYSONS BOULEVARD, SUITE 300, MCLEAN, VA, 22102, US

(73) Assignee: SANYO ELECTRIC CO., LTD., Osaka (JP)

(21) Appl. No.: 11/178,600

(22) Filed: Jul. 12, 2005

(30) Foreign Application Priority Data
Jul. 12, 2004 (JP) 2004-205258

(51) Int. Cl. G09G 5/00

(52) U.S. Cl. 345/207

(57) ABSTRACT

A photo sensor is disposed on the same substrate as that of a display area. External light sensed by the photo sensor is inputted into a luminance adjustment controller, and luminance necessary to maintain constant contrast is obtained. A correction value corresponding to the luminance to be adjusted is outputted as a white reference voltage or a value of a CV power source to be fed back to the display area. Constant contrast of the display area can be maintained even when surrounding light intensity varies. Moreover, an amount of electric current is adjusted according to the ambient light, leading to reduction in power consumption and extension of operating life.

### BACKGROUND OF THE INVENTION

1. Field of the Invention

The present invention relates to a display device, and particularly to a display device which maintains constancy of contrast by adjusting luminance according to ambient light.

2. Description of the Related Art

A recent display device, which is represented by a liquid crystal display (LCD) or an organic EL display using an organic EL element, has been increasingly reduced in size and thickness, and extended in life.

The organic EL element, in particular, is self-luminous and does not require a backlight necessary for the liquid crystal display. Accordingly, the organic EL element is optimal for reducing the thickness of the display device. Moreover, the organic EL element does not limit viewing angles. The organic EL display is therefore highly expected to be put into practical use as a next-generation display device.

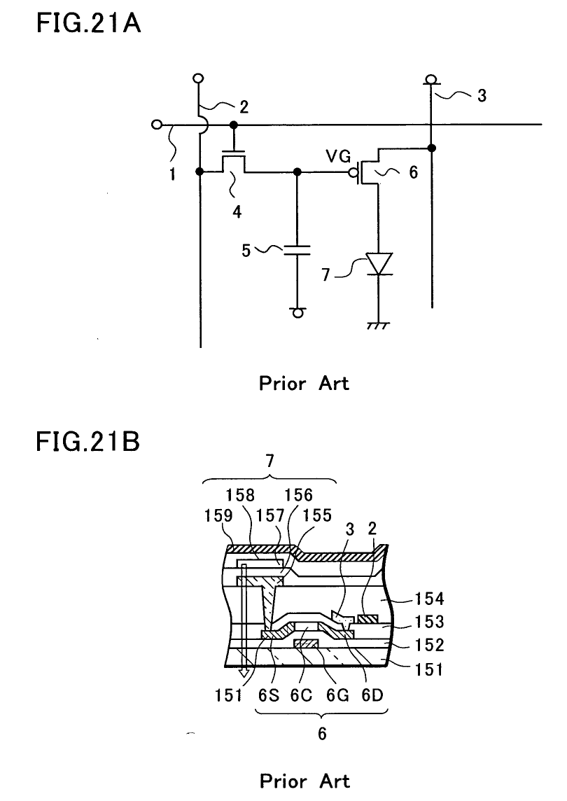

By the way, the methods of driving the organic EL display is of two types: a passive type of a simple matrix structure and an active type using TFTs. The active type generally uses a circuit configuration shown FIGS. 21A and 21B. FIG. 21A is a circuit diagram of a pixel of a display area of the organic EL display, and FIG. 21B is a cross sectional view of the pixel.

As shown in FIG. 21A, a plurality of gate lines 1 extending in a row direction of the figure are arranged, and a plurality of drain lines 2 and a plurality of driving lines 3 are arranged in a column direction thereof so as to cross the gate lines 1.

At each intersection of the gate lines 1 and the drain lines 2, a selection TFT 4 is connected to the gate lines 1 and drain lines 2. A gate and a drain of the selection TFT 4 are connected to the gate lines 1 and drain lines 2, respectively. The source of the selection TFT 4 is connected to a storage capacitor 5 and the gate of a driving TFT 6.

A drain and a source of the driving TFT 6 are connected to the driving line 3 and an anode of an organic EL element 7, respectively. The opposite electrode of the storage capacitor 5 is connected to a capacitance line (not shown) extending in the row direction.

The gate lines 1 are connected to a not-shown vertical scanning circuit, and gate signals are sequentially applied to the gate lines 1 by means of the vertical scanning circuit. The gate signal is a binary signal which becomes on or off. The gate signal has a predetermined positive voltage when it becomes on, and has OV when it becomes off. The vertical scanning circuit turns on a gate signal of a predetermined gate line selected out of the plurality of gate lines 1 connected thereto. When the gate signal of the selected gate line 1 is turned on, all of the selection TFTs 4 connected to the selected gate line 1 are turned on, and the drain lines 2 and the gates of the driving TFTs 6 are connected to each other through the selection TFTs 4.

Data signals determined according to pictures for display are outputted from a horizontal scanning circuit (not shown) to the drain lines 2. The data signals are inputted to the gates of the driving TFTs 6 and charged in the storage capacitors 5.

Each of the driving TFT 6 connects the driving line 3 and the organic EL element 7 at a conductivity according to a magnitude of the data signal. As a result of the above, an electric current according to the data signal is supplied from the driving line 3 through the driving TFT 6 to the organic EL element 7, and the organic EL element 7 therefore emits light at a luminance level according to the data signal.

Each of the storage capacitors 5 forms a capacitance in conjunction with another electrode such as the dedicated capacitance line or the driving line 3 and is capable of storing the data signal for a certain period of time.

Even after the vertical scanning circuit selects another gate line 1 and the previously selected gate line 1 becomes deselected state to turn off the selection TFT 4, the data signal is kept stored by the storage capacitor 5 for one vertical scanning period. During that period, the driving TFT 6 maintains the same conductivity as above, and the organic EL element 7 can continue to emit light at the same luminance level.

As shown in FIG. 21B, in the organic EL display, the driving TFT 6 is arranged on a glass substrate 151. The driving TFT 6 has such a structure that a gate electrode 6G is opposite to a source 6S, a channel 6C, and a drain 6D thorough a gate insulating film 152 interposed therebetween. The example shown in the drawing has a bottom gate structure in which the gate electrode 6G is located below the channel 6C.

On the driving TFT 6, an interlayer insulating film 153 is formed, on which the drain lines 2 and driving lines 3 are arranged. The driving line 3 is connected to the drain 6D of the driving TFT 6 through a contact. On the drain lines 2 and driving lines 3, a planarization insulating film 154 is formed. On the planarization insulating film 154, the organic EL element 7 is arranged for each pixel.

The organic EL element 7 includes an anode 155 formed of a transparent electrode of indium tin oxide (ITO) or the like, a hole transport layer 156, a light emitting layer 157, an electron transport layer 158, and a cathode 159 made of metal such as aluminum, which are sequentially stacked. As a result of recombining holes injected into the hole transport layer 156 from the anode 155 and electrons injected into the electron transport layer 158 from the cathode 159, light is emitted. As indicated by an arrow in the drawing, this emitted light is transmitted through the glass substrate 151 from the transparent anode 155 side and radiated to the outside. The anode 155 and light emitting layer 157 are separately formed for each pixel, and the hole transport layer 156, electron transport layer 158, and cathode 159 are formed in common with all the pixels. This technology is described in Japanese Patent Laid-open Publication No. 2002-251167.

As described above, the organic EL element constituting each pixel of the organic EL display is a current-driven type light emitting element which emits light according to electric current flowing between the anode and the cathode.

In the conventional organic EL display, the organic EL element emits light based on a luminance level adjusted before product shipment.

This causes a problem that, for example, in the open air, where ambient light intensity is high, contrast of the display area is reduced, and the display area is difficult to be observed.

Moreover, indoors or at night, where the display area has enough contrast, constant electric current is always supplied to the organic EL elements. This leads to problems that power consumption of the organic EL display cannot be reduced and the operating life of the organic EL elements cannot be extended.

### SUMMARY OF THE INVENTION

The invention provides a display device that includes a display area having a plurality of pixels arranged on a substrate and displaying an image, a photosensor provided on the substrate and configured to measure ambient light intensity, and a luminance adjustment controller outputting a signal to adjust a contrast of the image displayed in the display area based on the measured ambient light intensity.

The invention also provides a display device that includes a display area having a plurality of pixels arranged on a substrate, a photosensor provided on the substrate and configured to measure ambient light intensity, a luminance adjustment controller outputting a signal to adjust luminance of the pixels based on the measured ambient light intensity, and display data correction circuit adjusting image data supplied to the pixels based on the signal outputted from the luminance adjustment circuit.

The invention further provides a display device that includes a display area having a plurality of pixels arranged on a substrate, an electroluminescent element disposed in each pixel and having a light emitting layer disposed between an anode and a cathode, a thin film transistor disposed in each pixel and driving a corresponding electroluminescent element, a photosensor provided on the substrate and configured to measure ambient light intensity, a luminance adjustment controller outputting a signal to adjust luminance of the electroluminescent elements based on the measured ambient light intensity, a first power source connected with the thin film transistor and supplying a first power source voltage to the thin film transistor, a second power source connected with the electroluminescent element and supplying a second power source voltage to the electroluminescent element, a voltage changing circuit changing a potential between the first and second power sources based on the signal outputted from the luminescent adjustment controller.

### BRIEF DESCRIPTION OF THE INVENTION

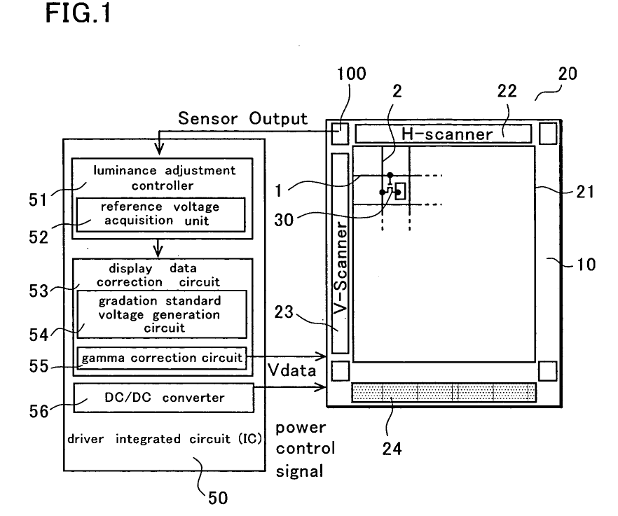

FIG. 1 is a schematic view showing an organic EL display device of a first embodiment of the present invention.

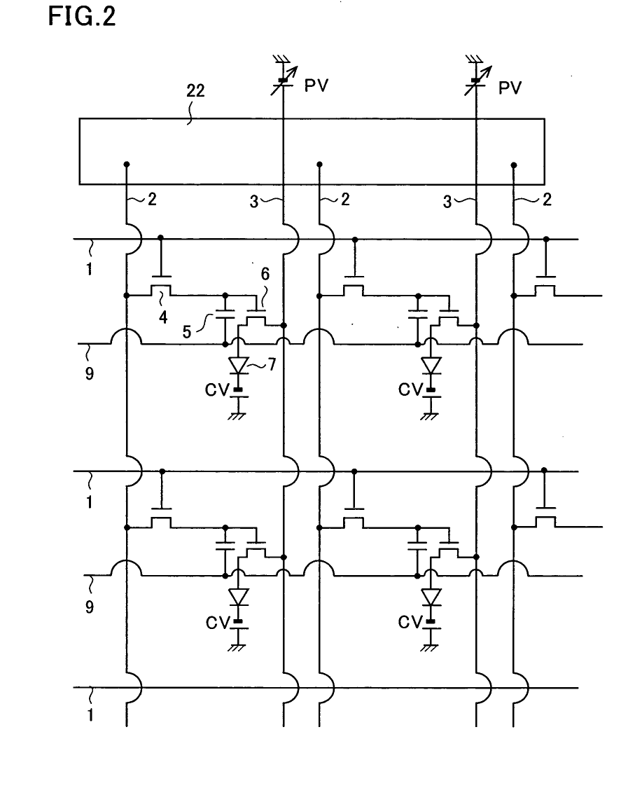

FIG. 2 is a circuit diagram explaining the organic EL display device of the first embodiment of the present invention.

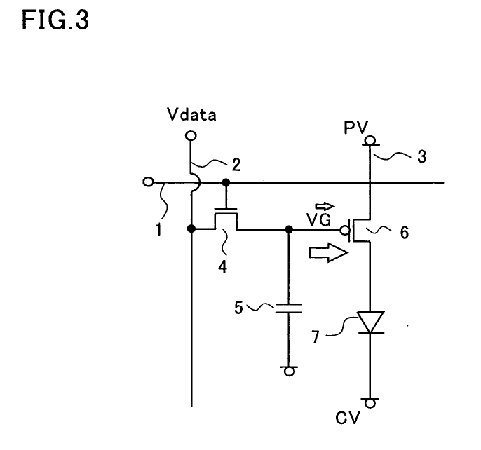

FIG. 3 is a circuit diagram explaining a one-pixel portion of a display area of the first embodiment of the present invention.

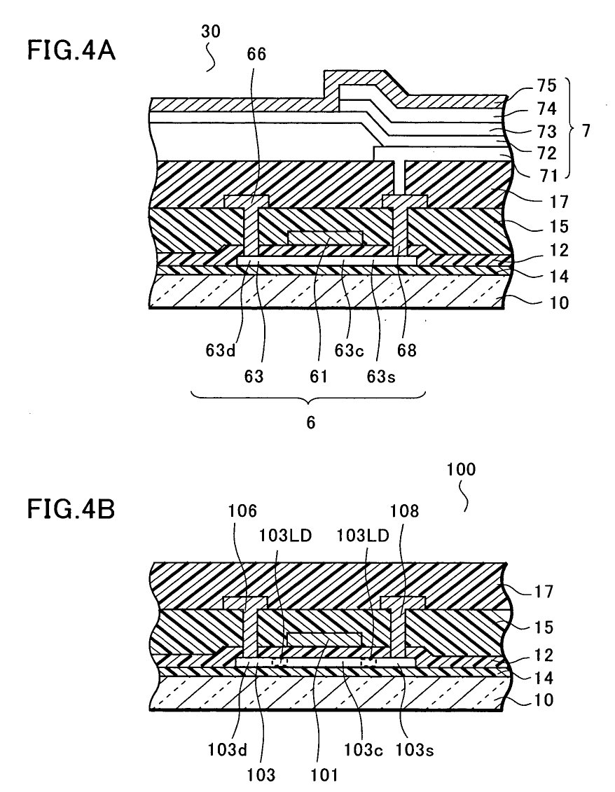

FIGS. 4A and 4B respectively are a cross-sectional view of a display pixel and a cross-sectional view of a photo sensor for explaining the organic EL display device of the first embodiment of the present invention.

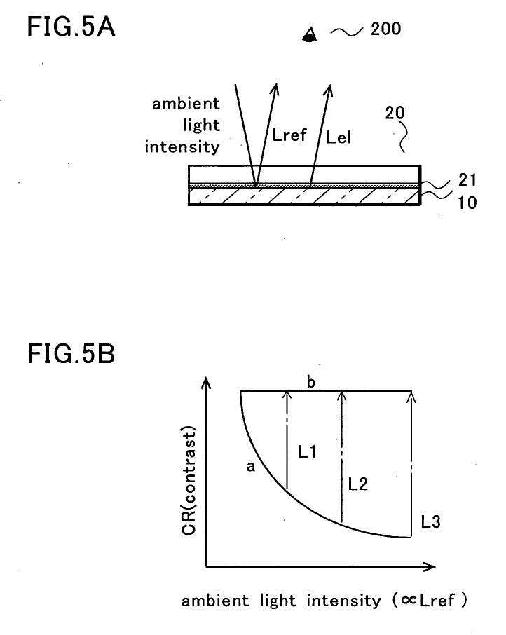

FIGS. 5A and 5B respectively are a schematic view and a characteristic chart explaining the organic EL display device of the first embodiment of the present invention.

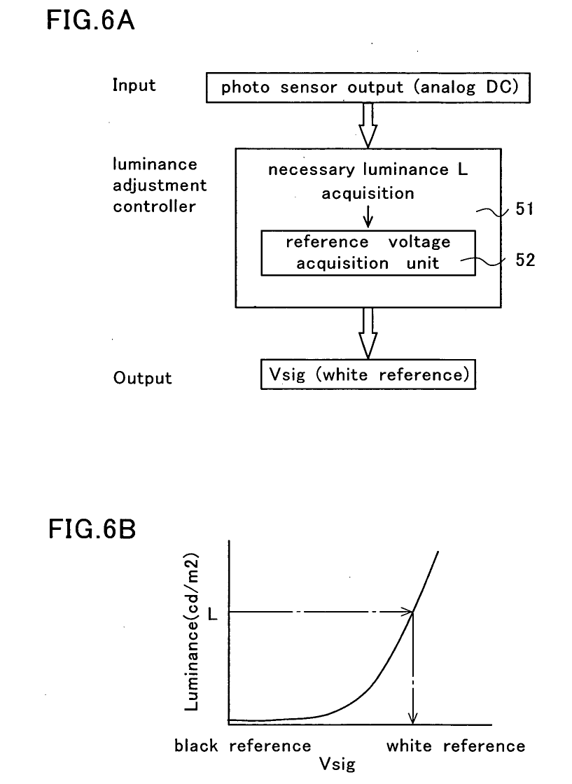

FIGS. 6A and 6B respectively are a block diagram and a characteristic chart explaining the organic EL display device of the first embodiment of the present invention.

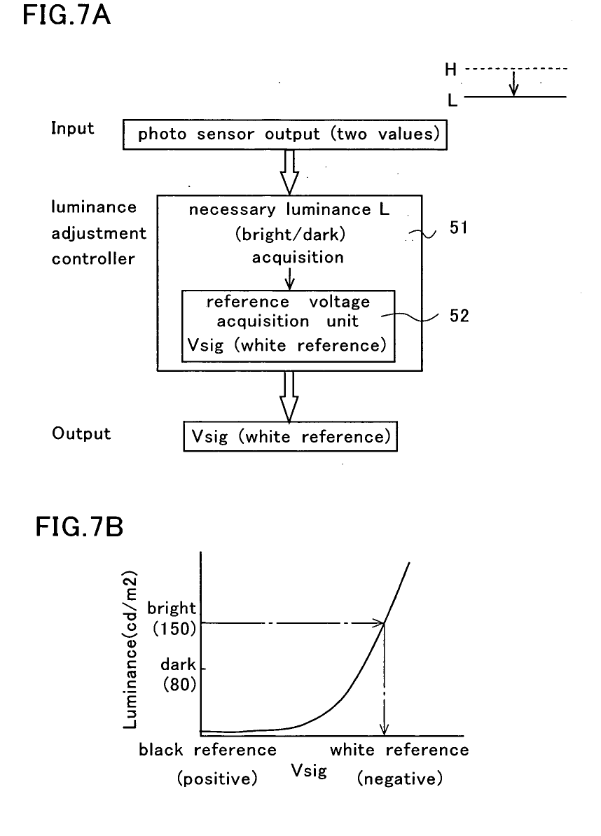

FIGS. 7A and 7B respectively are a block diagram and a characteristic chart explaining the organic EL display device of the first embodiment of the present invention.

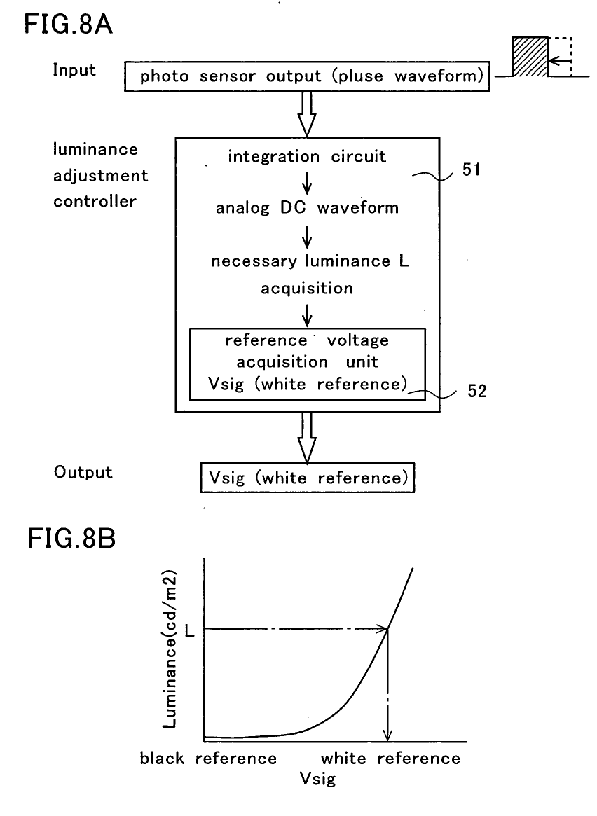

FIGS. 8A and 8B respectively are a block diagram and a characteristic chart explaining the organic EL display device of the first embodiment of the present invention.

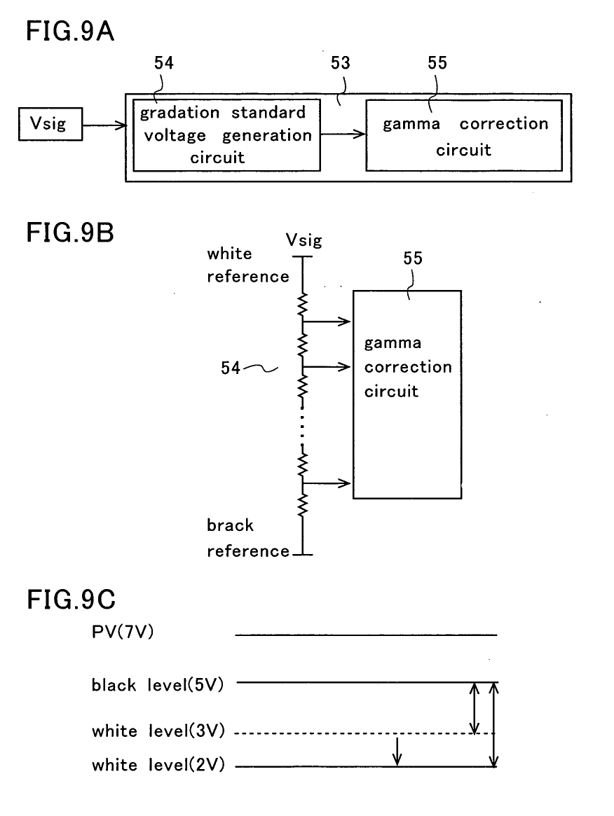

FIGS. 9A to 9C respectively are a block diagram, a circuit diagram, and a conceptual diagram explaining a reference voltage of the organic EL display device of the first embodiment of the present invention.

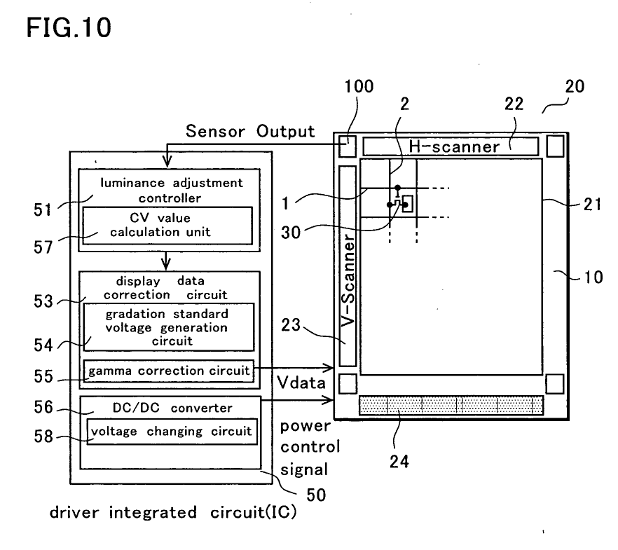

FIG. 10 is a schematic view showing an organic EL display device of a second embodiment of the present invention.

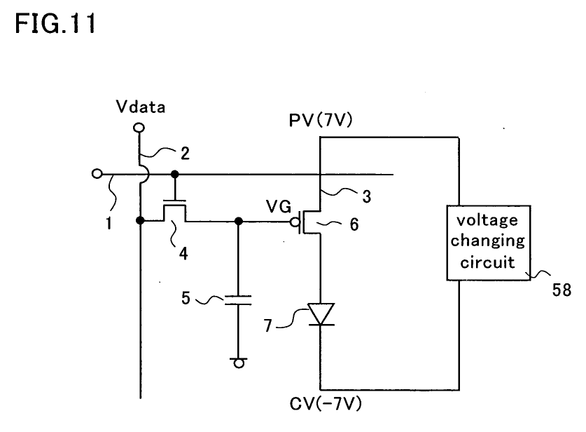

FIG. 11 is a circuit diagram of a pixel for explaining a display area of the second embodiment of the present invention.

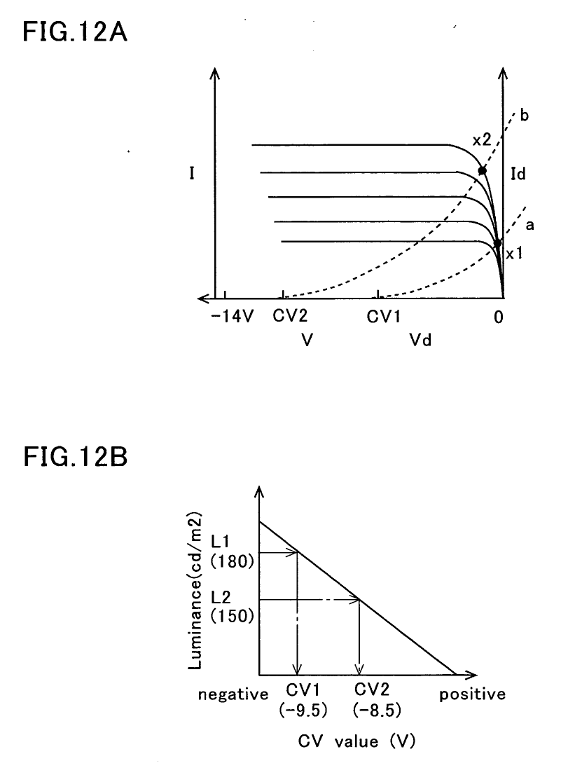

FIGS. 12A and 12B are characteristic charts explaining the organic EL display device of the second embodiment of the present invention.

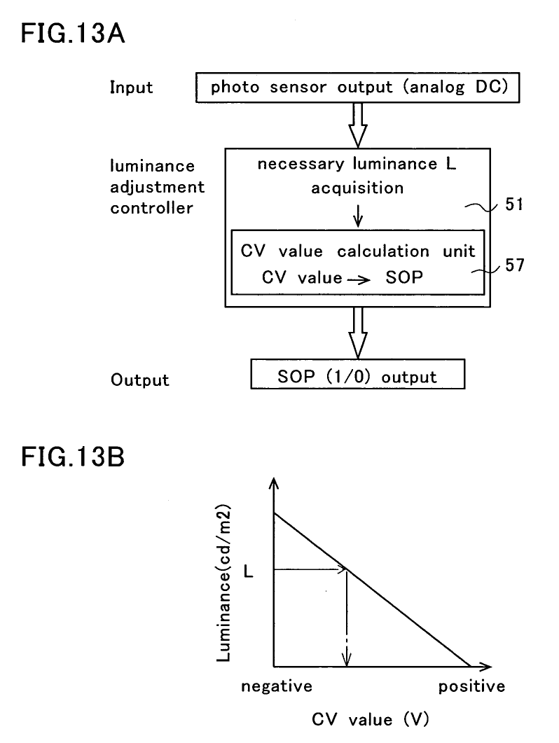

FIGS. 13A and 13B respectively are a block diagram and a characteristic chart explaining the organic EL display device of the second embodiment of the present invention.

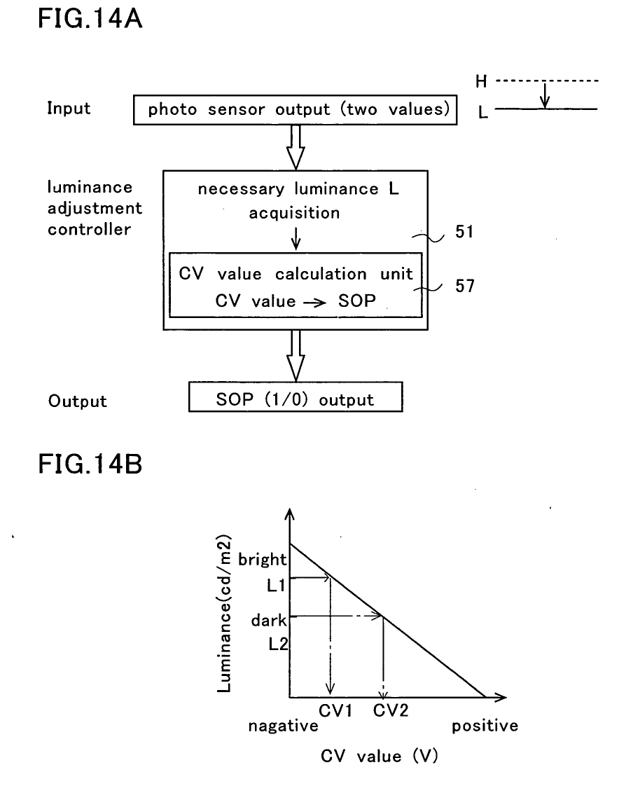

FIGS. 14A and 14B respectively are a block diagram and a characteristic chart for explaining the organic EL display device of the second embodiment of the present invention.

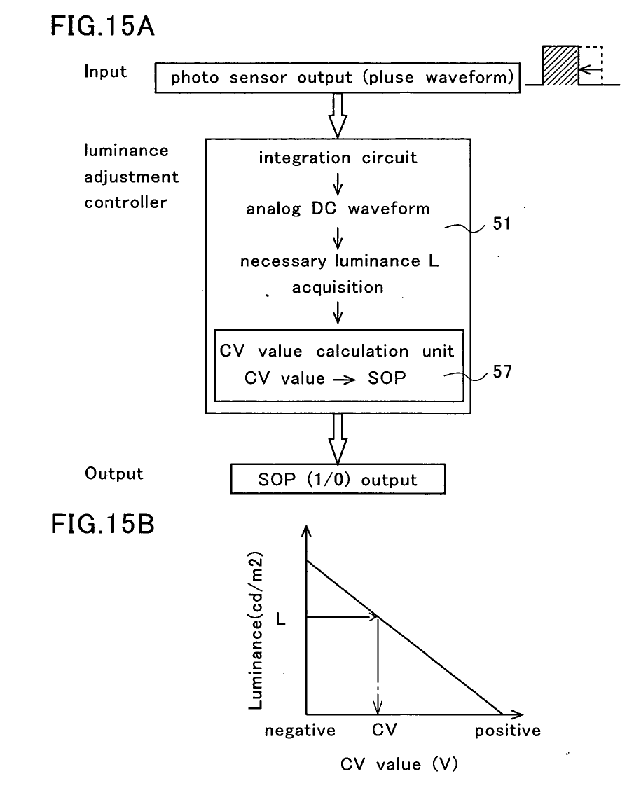

FIGS. 15A and 15B respectively are a block diagram and a characteristic chart for explaining the organic EL display device of the second embodiment of the present invention.

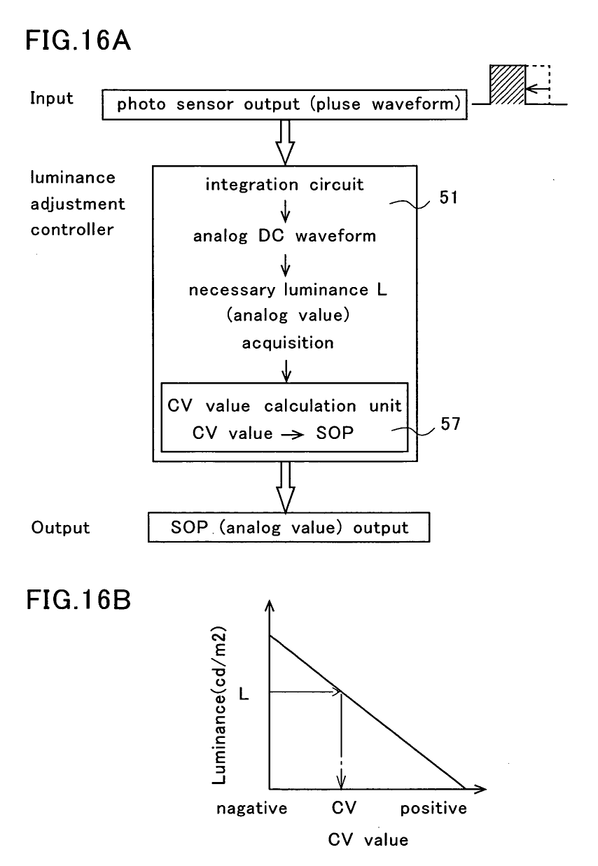

FIGS. 16A and 16B respectively are a block diagram and a characteristic chart for explaining the organic EL display device of the second embodiment of the present invention.

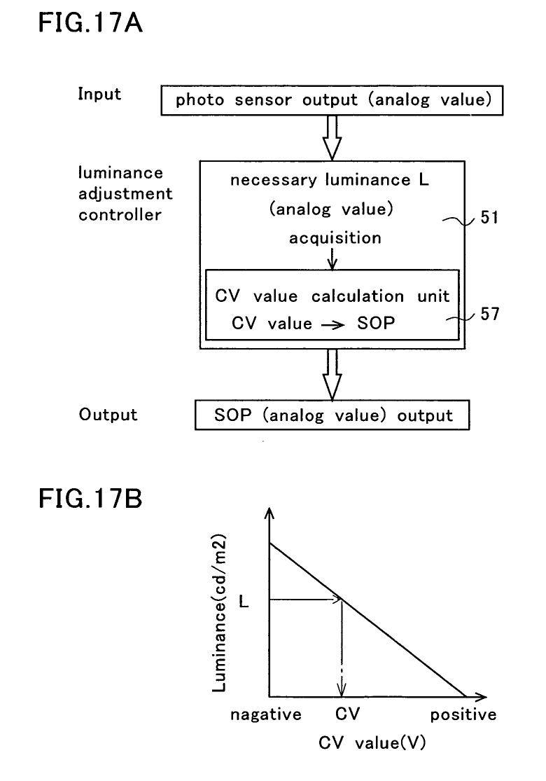

FIGS. 17A and 17B respectively are a block diagram and a characteristic chart for explaining the organic EL display device of the second embodiment of the present invention.

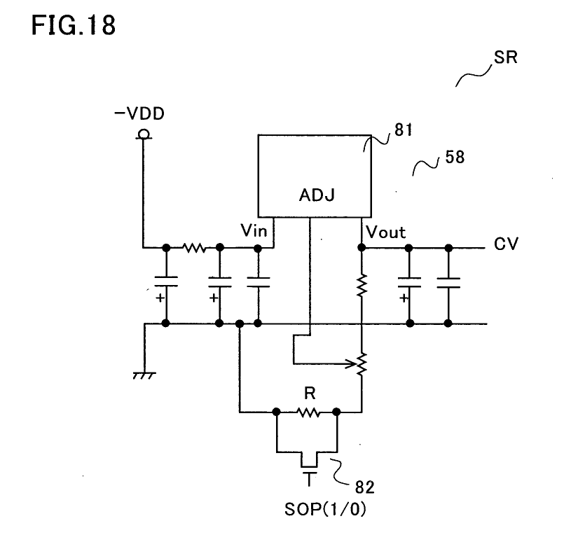

FIG. 18 is a circuit diagram for explaining the organic EL display device of the second embodiment of the present invention.

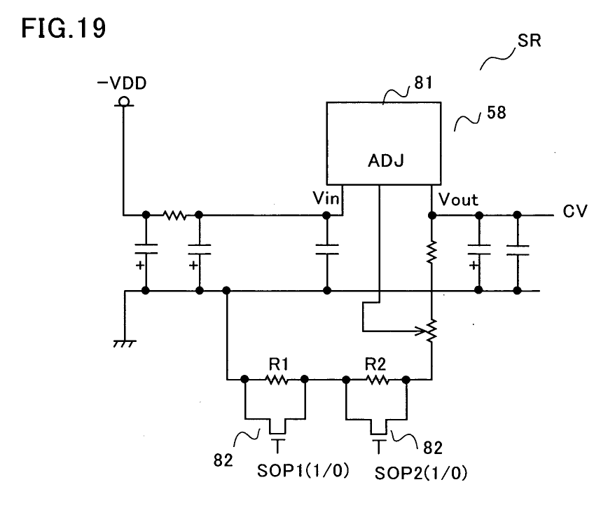

FIG. 19 is a circuit diagram for explaining the organic EL display device of the second embodiment of the present invention.

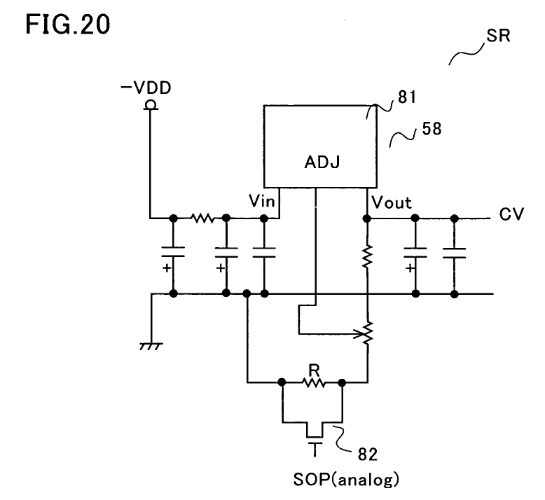

FIG. 20 is a circuit diagram for explaining the organic EL display device of the second embodiment of the present invention.

FIGS. 21A and 21B respectively are a circuit diagram and a cross-sectional view for explaining a conventional organic EL display device.

### DETAILED DESCRIPTION OF PREFERRED EMBODIMENTS

With reference to FIGS. 1 to 20, a detailed description will be given of embodiments of the present invention taking as an example an active matrix type organic EL display using TFTs.

FIGS. 1 to 9C are views explaining a first embodiment of the present invention and explain a case of adjusting luminance of a display area in a display data correction circuit.

FIG. 1 is a schematic view showing a configuration of a display device.

A display device 20 includes a display area 21, a photo sensor 100, and a driver integrated circuit (IC) 50.

The display area 21 is formed of a plurality of display pixels 30 arranged in a matrix on an insulating substrate 10 of glass or the like. Each of the display pixels 30 includes an EL element having a light emitting layer between an anode and a cathode, a driving transistor to drive the EL element, and a selection transistor. Both of the driving and selection transistors are thin film transistors (hereinafter, referred to as TFTs).

On the substrate 10, a plurality of drain lines 2 and a plurality of gate lines 1 are arranged, and the display pixels 30 are arranged corresponding to individual intersections of the drain lines 2 and the gate lines 1. To be specific, the display pixels 30 are connected to sources of the driving TFTs, and the drains and gates of the driving TFTs are connected to the drain lines 2 and gate lines 3, respectively.

On the outside of the display area 21, along its side edges, a horizontal scanning circuit (hereinafter, referred to as an H scanner) 22, which sequentially selects the drain lines 2 extending in the column direction, and a vertical scanning circuit (hereinafter, referred to as a V scanner) 23, which supplies gate signals to the gate lines 1 extending in the row direction, are provided. Not-shown wires for transmitting various types of signals inputted into the gate lines 1 and drain lines 2 and the like are gathered in a side edge of the substrate 10 and connected to an external connection terminal 24.

The photo sensor 100 comprises a TFT provided on the same substrate (plane) as that of the display area 21. In the photo sensor 100, a photocurrent is obtained according to light irradiated when the TFT is off. In other words, the photo sensor 100 is to sense ambient light and detect a photocurrent according to the ambient light intensity.

The driver IC 50 includes a luminance adjustment controller 51 adjusting luminance and a display data correction circuit 53 outputting data signals Vdata to the display area 21. The driver IC 50 further includes a DC/DC converter 56 and applies driving voltage to the driving TFTs connected to the organic EL elements to cause the organic EL elements to emit light.

The luminance adjustment controller 51 of the first embodiment includes a reference voltage acquisition unit 52, and according to the ambient light intensity detected by the photo sensor 100, outputs a correction value for maintaining constant contrast of the display area 21.

In this embodiment, first, the ambient light intensity is detected by the photo sensor 100. The detected ambient light intensity is inputted into the luminance adjustment controller 51. The correction value with which predetermined contrast can be maintained for the present ambient light intensity is calculated.

The display data correction circuit 53 includes a gradation standard voltage generation circuit 54 and a gamma correction circuit 55. The gradation standard voltage generation circuit 54 divides a voltage between first and second reference voltages to obtain a plurality of gradation display voltages. The gamma correction is to correct a proportional relation between outputted luminance and an inputted signal raised to the power of gamma into a proportional relation between the outputted luminance and the inputted signal.

The first reference voltage with a lower potential corresponds to a maximum luminance level (white) of the EL element of the display pixel 30, and the second reference voltage with a higher potential corresponds to a minimum luminance level (black) of the EL element thereof. In the present specification hereinbelow, the first and second reference voltages are referred to as white and black reference voltages, respectively.

The correction value is inputted to the display data correction circuit 53 and set as the white reference voltage of the gradation standard voltage generation circuit 54. The gradation standard voltage generation circuit 54 divides the voltage between the white and black reference voltages for each RGB color to generate the plurality of gradation display voltages. The display data correction circuit 53 carries out D/A (digital-analog) conversion of the data signals to generate analog RGB data signals based on the plurality of gradation display voltages. The analog RGB data signals are further corrected by the gamma correction circuit 55. The data signals Vdata are outputted to the display area 21 to display an image. Thus, the display area 21 can perform gradation display based on the gradation display voltages.

In this embodiment, the correction value to obtain a predetermined contrast according to the ambient light intensity is calculated and set as the white reference voltage of the gradation standard voltage generation circuit 54.

FIG. 2 is an equivalent circuit diagram of the display device 20.

The plurality of gate lines 1 extending in the row direction are arranged, and the plurality of the drain lines and driving lines 3 are arranged in the column direction in order for them to cross the gate lines 1. Each of the driving lines 3 is connected to a power source PV. The power source PV is a power source outputting, for example, a positive constant voltage.

At each intersection of the gate lines 1 and drain lines 2, a selection TFT 4 is connected to the gate lines 1 and drain lines 2. The gate and drain of the each selection TFT 4 are connected to the gate lines 1 and drain lines 2, respectively. The source of the each selection TFT 4 is connected to a storage capacitor 5 and a driving TFT 6.

The drain of the driving TFT 6 is connected to the driving line 3, and the source thereof is connected to an anode of an organic EL element 7. A cathode of the each organic EL element 7 is connected to a power source CV. The power source CV is a power source outputting, for example, a negative constant voltage. As long as the voltage of the power source PV is higher than that of the power source CV, the voltage of each power source may be either positive or negative. The opposite electrode of the storage capacitor 5 is connected to a capacitance line 9 extending in the row direction.

The gate lines 1 are connected to a not-shown V scanner, and gate signals are sequentially applied to the gate lines 1 by the V scanner. Each of the gate signals is a binary signal which becomes on or off. The gate signal has a predetermined positive voltage when it becomes on, and the gate signal is 0 V when it becomes off. The V scanner turns on the gate signal of a predetermined gate line selected out of the plurality of gate lines 1 connected thereto. When the gate signal is turned on, all of the selection TFTs 4 connected to the selected gate line 1 are turned on, and through the selection TFTs 4, the drain lines 2 and the gates of the driving TFTs 6 are connected.

The data signals Vdata determined according to pictures to be displayed are outputted from the H scanner 22 to the drain lines 2. The data signals Vdata are inputted to the gate of the individual driving TFTs 6 and are charged in the storage capacitors 5.

Each of the driving TFT 6 connects the driving line 3 and the organic EL element 7 with conductivities according to the magnitude of the data signal Vdata. Electric currents according to the data signal Vdata is then supplied from the driving line 3 through the driving TFT 6 to the organic EL element 7, and the organic EL element 7 emit light with luminance according to the data signal Vdata.

Each of the storage capacitors 5 forms a capacitance in conjunction with another electrode such as the dedicated capacitance line 9 or the driving line 3 and is capable of storing a data signal for a certain period of time.

The data signals Vdata are stored by the storage capacitors 5 during one vertical scanning period after the V scanner selects another gate line 1 and the previously selected gate line 1 becomes unselected state to turn off the selection TFTs 4. During that period, the driving TFTs 6 maintain the same conductivities as described above, and the organic EL elements 7 can continue to emit light at the same luminance.

FIG. 3 is a circuit diagram showing the power source PV, the driving TFT 6, the organic EL element 7, and the power source CV of a one-pixel portion extracted from the circuit diagram shown in FIG. 2. As apparent from the drawing, the driving TFT 6 and the organic EL element 7 are connected in series between the positive power source PV and the negative power source CV. A driving current which flows through the organic EL element 7 is supplied from the power source PV through the driving TFT 6 to the organic EL element 7. The driving current can be controlled by changing a gate voltage VG of the driving TFT 6. As previously described, the data signal Vdata is inputted to the gate electrode, and the gate voltage VG becomes a value according to the data signals Vdata.

In this embodiment, as shown in FIG. 1, the correction value outputted from the luminance adjustment controller 51 is set as the white reference voltage of the gradation standard generation circuit 54. The data signals Vdata outputted from the display data correction circuit 53 are therefore data with the luminance adjusted according to the ambient light intensity. In other words, the luminance of the organic EL element 7 can be adjusted by applying the corrected data signals Vdata as the gate voltage VG in FIG. 3.

FIGS. 4A and 4B are cross-sectional views explaining structures of one pixel of the display pixels 30 and the photo sensor 100, respectively. FIG. 4A is a partial cross-sectional view of the display pixel 30, and FIG. 4B is a cross-sectional view of the photo sensor 100. The display pixels 30 and photo sensor 100 are provided on the same substrate.

In the display pixel 30, an insulating film (SiN, SiO₂, or the like) 14 as a buffer layer is provided on an insulating substrate 10 made of quarts, alkali-free glass, or the like. On the insulating film 14, a semiconductor layer 63 made of a p-Si (poly-silicon) film is laminated. This p-Si film may be formed by laminating an amorphous silicon film followed by recrystallization by laser annealing or the like.

On the semiconductor layer 63, a gate insulating film 12 made of SiN, SiO₂, or the like is laminated, on which a gate electrode 61 is formed of refractory metal such as chromium (Cr) and molybdenum (Mo). The semiconductor layer 63 includes a channel 63c, which becomes intrinsic or substantially intrinsic, located under the gate electrode 61. On the both sides of the channel 63c, a source 63s and a drain 63d as n+ type impurity diffused regions are provided to constitute the driving TFT 6. The selection TFT, for which a drawing is omitted, has the same structure.

On the entire surface of the gate insulating film 12 and the gate electrode 61, a SiO₂ film, a SiN film, a SiO₂ film in this illustrative order are sequentially stacked to laminate an interlayer insulating film 15. Contact holes are provided in the gate insulating film 12 and interlayer insulating film 15 in a manner that the contact holes correspond to the drain 63d and the source 63s, and the contact holes are then filled with metal such as aluminum (Al) to form drain electrodes 66 and source electrodes 68, respectively. The drain electrodes 66 and source electrodes 68 are configured to be in contact with the drain 63d and the source 63s, respectively. On a planarization insulating film 17, an anode 71 of ITO (indium tin oxide) or the like is provided as a display electrode. The anode 71 is connected to the source electrode 68 (or the drain electrode 66) through a contact hole provided in the planarization insulating film 17.

The organic EL element 7 includes a hole transport layer 72, a light emitting layer 73, and an electron transport layer 74 stacked on the anode 71 in this order, and further includes a cathode 75 formed of a magnesium-indium alloy. The cathode 75 is provided for the entire surface of the substrate 10 forming the organic EL display device 20 or the entire surface of the display area 21.

In the organic EL element 7, holes injected from the anode 71 and electrons injected from the cathode 75 are recombined inside the light emitting layer 73 to excite organic molecules forming the light emitting layer 73 and generate exciters. In a process of radiative deactivation of the exciters, light is radiated from the light emitting layer 73. The light is released from the transparent anode 71 through the transparent insulating substrate 10 to the outside for luminescence.

The cross-sectional view of FIG. 4A is just an example and shows a so-called top gate structure. However, the structure of the pixels 30 is not limited to this and may be a bottom gate structure in which the gate electrode 61 and the semiconductor layer 63 are stacked in an order reverse to that of the above example. Moreover, the example in the drawing has a bottom emission structure where light emits toward the substrate 10. However, the structure may be a top emission structure where light is emitted in a direction (upward in the paper) opposite to the substrate 1, by having each layer of the organic EL element 7 stacked in the order reverse to the above example.

As shown in FIG. 4B, the photo sensor 100 is substantially the same as the driving TFT 6 of the display pixel 30, and a description of the redundant part will be omitted.

Specifically, the photo sensor 100 is a TFT in which a gate electrode 101, an insulating film 102, and a semiconductor layer 103 made of a p-S film are stacked on the insulating substrate 10 and the semiconductor layer 103 includes a channel 103c, a source 103s, and a drain 103d.

In the p-Si TFT of such a structure, when incident light enters the semiconductor layer 103 from the outside while the TFT is off, electron-hole pairs are generated in a junction region between the channel 103c and the source 103s or between the channel 103c and drain 103d. These electron-hole pairs are drawn apart by an electric field of the junction region to generate a photovoltaic, whereby a photocurrent is obtained. The photocurrent is outputted from, for example, the source electrode 108 side.

In other words, the TFT is utilized as the photo sensor 100 by sensing the increase in photocurrent obtained when the TFT is off.

Here, the semiconductor layer 103 may be provided with a low concentration impurity region. The low concentration impurity region is provided in adjacent to the source 103s or the drain 103d on the channel 103c side and has a lower impurity concentration than that of the source 103s or the drain 103d. The low-concentration impurity region can reduce the electric field concentrated in an edge portion of the source 103s (or drain 103d). The width of the low concentration impurity region is, for example, about 0.5 to 3 μm.

In this embodiment, a low concentration impurity region 103LD is provided, for example, between the channel and the source (or between the channel and the drain) to form a so-called light doped drain (LDD) structure. In the LDD structure, the junction region contributing to generation of the photocurrent can be extended in the direction of the gate length L, thus facilitating generation of the photocurrent. Specifically, the low concentration impurity region 103LD may be provided at least on a side from which the photocurrent is taken out. Moreover, the LDD structure stabilizes an OFF characteristic (region for detection) of Vg-Id characteristics, thus the device can be made stable.

The above description has been given to the photo sensor 100 of the top gate structure. The photo sensor 100 may have the bottom gate structure where the gate electrode 101 is arranged under the semiconductor layer 103. The drawing shows only the TFT as the photo sensor 100. However, the TFT may be connected to a detection circuit and convert the photocurrent into voltage for detection when necessary.

A description will be given of contrast with reference to FIGS. 5A and 5B. FIG. 5A is a schematic view of the display area 21, and FIG. 5B is a characteristic chart showing a relation between the ambient light intensity and the contrast of the display area 21.

As shown in FIG. 5A, the display area 21 includes a number of the organic EL elements constituting the pixels, and these organic EL elements are formed by stacking the anode, electron transport layer, light emitting layer, hole transport layer, and cathode on the substrate (see FIG. 4A). Luminance (light intensity) of the display area 21 recognized by a user 200 is reflected light luminance Lref according to the ambient light intensity and self-emitted light luminance Lel of the organic EL elements.

Contrast CR, the self-emitted light luminance Lel, and the reflected light luminance Lref have a relation expressed by the following equation.
CR=1+Lel/Lref

The reflected light luminance Lref has a proportional relation with the ambient light intensity, and the higher the ambient light intensity, the larger the reflected light luminance Lref is. If the self-emitted light luminance Lel of the organic EL element is constant at this time, the self-emitted light luminance Lel is reversed with a magnitude of the reflected light luminance Lref. This means that the contrast is reduced and has a characteristic indicated by a solid line a of FIG. 5B. On the other hand, increasing the self-emitted light luminance Lel of the organic EL element according to the ambient light intensity allows the display area 21 to maintain constant contrast as indicated by a solid line b.

In this specification, luminance L (L1, L2 or L3) necessary for keeping the contrast CR constant in certain ambient light is referred to as necessary luminance L.

In addition, the contrast CR satisfies the following relation.
CR=(Lel(white)+Lel(black)+Lref)/(Lel(black)+Lref)=1+Lel(white)/(Lel(black)+Lref)
where Lel(white) denotes luminance of white, and Lel(black) denotes luminance of black.

At the time of product shipment, adjustment has been carried out in order that enough contrast CR can be obtained indoors (i.e., that black can be sufficiently observed as black). The Lel(black) is low enough, and this value does not change even in the open air. Specifically, the Lel(black) is around 0 (anywhere either indoors or in the open air) independent of the value of the Lref.

The contrast CR is a difference between the Lel(white) and Lel(black), and the Lel(black) is low enough and close to 0 independent of the reflected light luminance Lref as described above. When the contrast CR is reduced, therefore, an increase in the Lel(white) enables the contrast CR to be maintained constant.

Meanwhile, the photo sensor 100 outputs a photocurrent according to the ambient light as described above. Specifically, the photo sensor 100 includes analog and digital outputs corresponding to the ambient light, and the relation between the photocurrent and the ambient light can be obtained by measuring the characteristics of the photo sensor 100 beforehand.

In this embodiment, the necessary luminance L is calculated according to the ambient light, and the reference voltage determining the Lel(white) is corrected. Using the data signal Vdata thus obtained, the value of the gate voltage VG of the driving TFT 6 can be adjusted as shown in FIG. 3, and the self-emitted light luminance Lel according to the ambient light can be obtained.

With reference to FIGS. 6A to 8B, the luminance adjustment controller 51 will be described. The luminance adjustment controller 51 of the first embodiment includes the reference voltage acquisition unit 52, and as described above, the luminance adjustment controller 51 receives a detection result of the photo sensor 100 (photo sensor output) and outputs the correction value. The format of the received input data varies depending on the structure of a detection circuit of the photo sensor 100 and is one of three types: where a DC value changes with luminance in an analog manner (FIGS. 6A and 6B); where a DC value changes with luminance in a digital manner (FIGS. 7A and 7B); and where an area of a pulse waveform changes with luminance (FIGS. 8A and 8B). In this embodiment, based on the input data, the luminance adjustment controller 51 outputs a correction value Vsig, which is set as the white reference voltage of the gradation standard voltage generation circuit 54.

With reference to FIGS. 6A and 6B, a description will be given of the case where the detection result of the photo sensor 100 (photo sensor output) is a DC value varying with the luminance in an analog manner. FIG. 6A is a block diagram showing the luminance adjustment controller 51 and input/output data, and FIG. 6B shows an example of a characteristic chart held by the reference voltage acquisition unit 52.

First, the light intensity is detected by the photo sensor 100. For example, analog values of current and voltage according to the light intensity are detected and inputted into the luminance adjustment controller 51.

In the luminance adjustment controller 51, the necessary luminance L to maintain constant contrast is obtained based on the current and voltage values according to the ambient light-CR characteristic chart (FIG. 5B). This necessary luminance L takes account of the reflected light luminance Lref and the self-emitted light luminance Lel.

Next, the necessary luminance L is inputted in the reference voltage acquisition unit 52. Between the reference voltage of the gradation standard voltage generation circuit 54 and the luminance, there is a relation as shown in FIG. 6B. Specifically, the reference voltage acquisition unit 52 acquires a reference voltage corresponding to the necessary luminance L, that is, the correction value Vsig, according to the characteristic chart as shown in FIG. 6B. The correction value Vsig (for example, 3V) is set as the white reference voltage of the gradation standard voltage generation circuit 54, and gamma-correction is performed in the gamma correction circuit 55. The obtained signal is then transmitted to the display area 21 as the data signal Vdata for the drain lines 2 (see FIG. 1).

With reference to FIGS. 7A and 7B, a description will be given of the case where the detection result of the photo sensor 100 changes in two values depending on the luminance. FIG. 7A is a block diagram of the luminance adjustment controller 51, and FIG. 7B is an example of a characteristic chart held by the reference voltage acquisition unit 52.

First, the light intensity is detected by the photo sensor 100. For example, in the case of certain ambient light, the on/off state of the photo sensor 100 is detected, and the signal (1/0) thereof (photo sensor output) is inputted into the luminance adjustment controller 51.

In the luminance adjustment controller 51, the necessary luminance L to maintain substantially constant contrast is obtained based on the input signal according to the ambient light-CR characteristic chart (FIG. 5B). In this case, the necessary luminance L takes two values, for example, “bright” and “dark”, and which one of the values can maintain substantially constant contrast is determined. This necessary luminance L takes account of the reflected light luminance Lref and the self-emitted light luminance Lel.

Next, in the reference voltage acquisition unit 52, the correction value Vsig corresponding to the necessary luminance L is obtained according to the characteristic chart as shown in FIG. 7B. As an example, when the necessary luminance L is “bright” (150 cd/m²), the correction value Vsig is 2 V, and when the necessary luminance L is “dark” (80 cd/m²), the correction value Vsig is 3V. This correction value Vsig is outputted to the gradation standard voltage generation circuit 54.

With reference to FIGS. 8A and 8B, a description will be given of the case where the detection result of the photo sensor 100 is a pulse waveform and the shape thereof changes with luminance. FIG. 8A is a block diagram of the luminance adjustment controller 51, and FIG. 8B is an example of a characteristic chart held by the reference voltage acquisition unit 52.

First, the light intensity is detected by the photo sensor 100. The photo sensor 100 in this case changes, depending on luminance, with regard to timing when it becomes on, and the area of the pulse waveform during the on-state is integrated to obtain an analog value.

Specifically, the pulse waveform is inputted into the luminance adjustment controller 51 as shown in FIG. 8A. An integration circuit in the luminance adjustment controller 51 integrates the pulse waveform to calculate the area, thus obtaining an analog DC waveform.

In the luminance adjustment controller 51, the necessary luminance L for maintaining constant contrast is obtained based on the input signal (analog DC waveform) according to the ambient light-CR characteristic chart (FIG. 5B). This necessary luminance L takes account of the reflected light luminance Lref and the self-emitted light luminance Lel.

Next, in the reference voltage acquisition unit 52, the correction value Vsig corresponding to the necessary luminance L is obtained according to the characteristic chart as shown in FIG. 8B. The correction value Vsig is outputted to the gradation standard voltage generation circuit 54.

FIGS. 9A to 9C are views explaining the display data correction circuit 53. FIG. 9A is a block diagram, FIG. 9B is a circuit diagram of the gradation standard voltage generation circuit 54, and FIG. 9C is a conceptual chart of gradation display.

In the first embodiment, the display data correction circuit 53 includes the gradation standard voltage generation circuit 54 and the gamma correction circuit 55. The correction value Vsig outputted as described above is inputted into the gradation standard voltage generation circuit 54.

As shown in FIG. 9B, the gradation standard voltage generation circuit 54 is a resistance divider circuit in which a corresponding number of resistors to the number of gradations (256) are connected in series. The white reference voltage is a low potential reference voltage corresponding to the maximum luminance level (white) of the EL element constituting the pixel, and the black reference voltage is a high potential reference voltage corresponding to the minimum luminance level (black) of the EL element.

In this circuit, the black reference voltage is fixed, and the white reference voltage of the gradation standard voltage generation circuit 54 is set to be the correction value Vsig.

The gradation standard voltage generation circuit 54 generates gradation display voltages between the corrected white reference voltage (Vsig) and the black reference voltage (fixed value).

For example, when the white reference voltage is reduced, only the white level is reduced (3V to 2V) as shown in FIG. 9C, which means that the contrast is enhanced. Specifically, when the ambient light intensity (intensity of reflected light) is high and the contrast is reduced, the white reference voltage is set to be a lower value of the correction value Vsig, enabling the constant contrast to be maintained.

The correction is to change the white reference voltage, and black-and-white gradations are obtained by dividing the voltage range between the white and black reference voltages by resistors. Even when the white reference voltage is changed, therefore, the correction to maintain constant contrast can be performed without reducing the number of gradations.

256 analog voltages (gradation display voltages) for gradation display generated by the gradation standard voltage generation circuit 54 are outputted for each RGB color as the data signal Vdata through the gamma correction circuit 55 and drain signal lines to the display pixels 30 within the display area 21.

In the aforementioned example, the description has been given of the case where the white reference voltage is changed by the correction value Vsig. In addition thereto, the gamma characteristics used in the gamma correction may be changed.

In some cases, even the same color (for example, red) observed by the same user may look different indoors and outdoors. The gamma correction is to correct visibility of the gradations between black and white. It is therefore conceivable that the gamma characteristics may be changed due to the ambient light (reflected light). Accordingly, holding different gamma characteristics corresponding to the correction values Vsig, the gamma correction can be performed using a gamma characteristic suitable for that case, after the adjustment of the white reference voltage is performed according to the ambient light intensity.

The luminance adjustment by the first embodiment can be applied not only to the organic EL display of two transistor type (FIG. 3) in which the driving and selection TFTs are formed within a pixel, but also to that of threshold correction type (Vth type) including a transistor to correct a threshold value added to the two transistor type.

Moreover, the luminance adjustment can be applied an organic EL display of a type (hereinafter, referred to as a digital duty driving type) in which a light emission period changes in proportion to a reference voltage. In the case of the digital duty driving type, the light emission period of the organic EL element changes with the reference voltage. In other words, each element has its emission height (luminance while emitting light) being constant, but the entire luminance of the display area can be changed by the reference voltage. Setting the white reference voltage to be the correction value Vsig therefore enables the contrast to be maintained constant.

Furthermore, the above description has been given taking as an example the organic EL display in which the display area 21 is composed of the display pixels 30 using the organic EL elements, but the display device is not limited to this. The display device 20 including pixels with driving TFTs formed of low-temperature polysilicon, such as LCD, can be implemented in a similar way. Specifically, only with the display device 20 replaced with the LCD or the like in FIG. 1, a similar configuration can be applied to the driver IC 50, and similar effects can be obtained.

Next, a description will given of a case as a second embodiment where luminance of a device is adjusted by a value of a power source CV which supplies one of power source voltages of the driving TFT with reference to FIGS. 10 to 20. The second embodiment is mainly suitable for an organic EL display device of the digital duty drive type.

FIG. 10 is a schematic view showing a configuration of the organic EL display.

The organic EL display includes a display area 21, a photo sensor 100, and a driver integrated circuit 50.

The display area 21 and the photo sensor 100 are the same as those of the first embodiment, and details thereof are omitted.

The driver IC 50 includes a luminance adjustment controller 51 adjusting luminance and a display data correction circuit 53 outputting data signals Vdata to the display area 21. The driver IC 50 further includes a DC/DC converter 56 and applies a driving voltage to the driving TFTs connected to the organic EL elements to cause the organic EL elements to emit light.

The luminance adjustment controller 51 of the second embodiment includes a CV value calculation unit 57 and outputs a correction value to maintain constant contrast of the display area 21 according to ambient light intensity sensed by the photo sensor 100.

The luminance adjustment controller 51 includes a voltage changing circuit 58 within the DC/DC converter 56, which supplies a power source voltage of the driving TFTs driving the organic EL elements. The correction value outputted from the luminance adjustment controller 51 is inputted into the voltage changing circuit 58, and the power source voltage applied to the driving TFTs is changed to adjust the contrast of the display area 21.

The display data correction circuit 53 performs digital/analog (D/A) conversion of the data signals, and analog RGB data signals generated using the plurality of gradation display voltages are corrected in a gamma correction circuit 55. The data signals Vdata are outputted to drain lines 2, thus displaying an image.

An equivalent circuit diagram of the organic EL display device 20 is the same as that of the first embodiment (FIG. 2), and a description thereof is omitted.

FIG. 11 shows a circuit diagram of a one-pixel portion of this embodiment. The drain of the driving TFT 6 is connected to a driving line 3, and the driving line 3 is connected to the power source PV. The power source PV is a power source outputting, for example, positive constant voltage. The source thereof is connected to an anode of an organic EL element 7. A cathode of the organic EL element 7 is connected to a power source CV. The power source CV is a power source outputting, for example, negative constant voltage. The potentials of the power sources PV and CV should satisfy a relation: power source PV>power source CV, and whether each power source voltage is positive or negative is not limited to the above description.

The driving TFT 6 and the organic EL element 7 are connected in series between the power sources PV and CV. A driving current which flows through the organic EL element 7 is supplied from the power source PV through the driving TFT 6 to the organic EL element 7. The light emitting layer of the organic EL element 7 emits light according an amount of the driving current.

In the second embodiment, the power sources PV and CV are generated by the DC/DC converter 56. The power source PV is fixed, and the power source CV can be varied by the power source changing circuit 58. Details of the power source changing circuit 58 are described later. In this embodiment, the ambient light intensity is detected by the photo sensor 100, and a correction value to maintain predetermined contrast is calculated by the luminance adjustment controller 51. The correction value is inputted to the power source changing circuit 58, and the power source CV is changed according to the correction value. Upon the power source PV and the corrected power source CV being applied between the driving TFT 6 and the organic EL element 7, the organic EL element 7 emits light according to the potential difference thereof, and the display area 21 can maintain predetermined contrast.

As shown in FIG. 5B, when the ambient light and reflected light luminance Lref are increased while the self-emitted light luminance Lel of the organic EL element is constant, the contrast is reduced (a solid line a in FIG. 5B).

On the other hand, by increasing the self-emitted light luminance Lel or the intensity of self-emitted light of the organic EL element according to the ambient light intensity, the contrast of the display area 21 can be maintained constant (a solid line b in FIG. 5B).

Additionally, the photo sensor 100 has an analog output for ambient light, and a relation between ambient light and a photocurrent can be obtained by measuring the characteristic of the photo sensor 100 beforehand. In other words, when the contrast decreases, certain constant contrast can be maintained by changing the voltage applied between the driving TFT 6 and the organic EL element 7 and increasing the self-emitted light luminance Lel. In the second embodiment, the power source PV is fixed, and the power source CV is changed.

With reference to FIGS. 12A and 12B, a description will be given of a reason for changing the value of the power source CV. FIG. 12A is a chart showing the Vd-Id characteristic of the driving TFT 6 and a V-I characteristic of the organic EL element 7 in the second embodiment. FIG. 12B is a chart showing a relation between the power source CV and luminance.

In FIG. 12A, the characteristics of the organic EL element 7 and the driving TFT 6 are indicated by dashed lines and solid lines, respectively. The intersections of these dashed and solid lines are operation points, and an electric current to be supplied to the organic EL element 7 is determined by these intersections. The standard voltage (cathode voltage) in the V-I characteristic of the organic EL element 7 is a value (hereinafter, referred to as a CV value) of the power source CV. In other words, the self-emitted light luminance Lel can be increased by increasing an absolute value of the CV value to increase the standard voltage and consequently to shift the starting point of the V-I characteristic to the negative side.

As an example, if CV1 (dashed line a) is changed into CV2 (dashed line b), the operating point rises (from x1 to x2). The organic EL element 7 can therefore operate in a region having large Id, and the self-emitted light luminance Lel can be increased.

As shown in FIG. 12B, the relation between the Cv value and luminance is substantially a proportional relation. Specifically, in the above example, the increase in the absolute CV value increases the self-emitted light luminance Lel. For example, the luminance can be increased from 150 cd/m² (CV1=−8.5 V) to 180 cd/m² (CV2=−9.5 V). In other words, the increase in the absolute CV value can raise the reduced contrast to predetermined contrast.

A description will be given of the luminance adjustment controller 51 of the second embodiment with reference to FIGS. 13A to 17B. The luminance adjustment controller 51 includes the CV value calculation unit 57. As described above, the luminance adjustment controller 51 receives a detection result of the photo sensor 100 (photo sensor output) and outputs a correction value. The format of the received input data varies depending on the structure of a detection circuit of the photo sensor 100 and is on of three types: where a DC value varies with luminance in an analog manner (FIGS. 13A, 13B, 17A, and 17B); where a DC value varies with luminance in a digital manner (FIGS. 14A and 14B); and where an area of a pulse waveform varies with luminance (FIGS. 15A to 16B). In this embodiment, the CV value is calculated based on the input data in the CV value calculating unit 57 and outputted as the correction value.

With reference to FIGS. 13A and 13B, a description will be given of the case where the detection result of the photo sensor 100 is a DC value varying with luminance in an analog manner. FIG. 13A is a block diagram showing the luminance adjustment controller 51, and FIG. 13B shows an example of a characteristic chart held by the CV value calculation unit 57.

First, the light intensity is detected by the photo sensor 100. For example, analog values of current and voltage according to the light intensity are detected and inputted into the luminance adjustment controller 51.

In the luminance adjustment controller 51, necessary luminance L to maintain constant contrast is obtained based on the current and voltage values according to the ambient light-CR characteristic chart (FIG. 5B). This necessary luminance L takes account of the reflected light luminance Lref and the self-emitted light luminance Lel.

Next, in the CV value calculation unit 57, a CV value corresponding to the necessary luminance L is obtained according to the characteristic chart shown in FIG. 13B. The power source CV is adjusted with the CV value, and the organic EL element 7 emits light at a predetermined luminance level.

In this embodiment, the calculated CV value is further converted into a signal which can be passed to the voltage changing circuit 58, and is then outputted. As the correction value, therefore, the value converted for passing, not the CV value itself, is outputted, which is hereinafter described as a correction value SOP. For example, in the case of FIGS. 13A and 13B, the correction value SOP is a signal (1/0) to determine a on/off state of a resistor of the voltage changing circuit 58. Moreover, depending on the configuration of the voltage changing circuit 58, a plurality of correction values as SOP1, SOP2 and so on may be required instead of the correction value SOP.

Furthermore, in the case where the CV value obtained in the CV value calculation unit 57 can be passed, without the change, as the voltage value of the power source CV, the CV value may be outputted as the correction value without being converted into the correction value SOP.

With reference to FIGS. 14A and 14B, a description will be given of the case where the detection result of the photo sensor 100 (photo sensor output) changes in two values depending on luminance. FIG. 14A is a block diagram of the luminance adjustment controller 51, and FIG. 14B is an example of the characteristic chart held by the CV value calculation unit 57.

First, the amount of light is detected by the photo sensor 100. For example, in the case of certain ambient light, an on/off state of the photo sensor 100 is detected, and the signal (1/0) thereof is inputted into the luminance adjustment controller 51.

In the luminance adjustment controller 51, the necessary luminance L to maintain substantially constant contrast is obtained based on the input signal according to the ambient light-CR characteristic chart (FIG. 5B). In this case, the necessary luminance L takes two values, for example, “bright” and “dark”, and which one of the values can maintain substantially constant contrast is determined. This necessary luminance L takes account of the reflected light luminance Lref and the self-emitted light luminance Lel.

Next, in a CV value calculation unit 52, a CV value corresponding to the necessary luminance L is obtained according to the characteristic chart as shown in FIG. 14B. As an example, CV1 is −9.5 V at necessary luminance L1 of “bright” (180 cd/m²), and CV2 is −8.5 V at necessary luminance L2 of “dark” (150 cd/m²). The CV value is converted into the signal which determines on/off of the resistor of the voltage changing circuit 58 as described above and outputted as the correction value SOP (1/0).

With reference to FIGS. 15A and 15B, a description will be given of the case where the detection result of the photo sensor 100 is a pulse waveform and the shape thereof changes with luminance. FIG. 15A is a block diagram of the luminance adjustment controller 51, and FIG. 15B is an example of the characteristic chart held by the CV value calculation unit 57.

First, the amount of light is detected by the photo sensor 100. The photo sensor 100 in this case changes in on time depending on luminance, and the area of a pulse section in the on time is integrated to obtain the analog value.

Specifically, the pulse waveform is inputted into the luminance adjustment controller 51 as shown in FIG. 15A. An integration circuit in the luminance adjustment controller 51 integrates the pulse waveform to calculate the area, thus obtaining an analog DC waveform.

In the luminance adjustment controller 51, the necessary luminance L to maintain constant contrast is obtained based on an analog value according to the ambient light-CR characteristic chart (FIG. 5B). This necessary luminance L takes account of the reflected light luminance Lref and the self-emitted light luminance Lel.

Next, in the CV value calculation unit 57, a CV value corresponding to the necessary luminance L is obtained according to the characteristic chart as shown in FIG. 15B. The CV value is converted to a signal which determines on/off of a resistor of the voltage changing circuit 58 to be outputted as the correction value SOP (1/0).

FIGS. 16A and 16B and FIGS. 17A and 17B show cases where formats of the input data are the same as those of FIGS. 15A and 15B and FIGS. 13A and 13B, respectively, and the correction value SOP is not binary but analog. The correction value SOP is binary (FIGS. 13A, 14A, and 15A) or analog (FIGS. 16A and 17A) depending on the structure of the voltage changing circuit 58 since the correction value SOP is inputted to the voltage changing circuit 58.

FIGS. 16A and 16B show the case where the detection result of the photo sensor 100 is a pulse waveform and the area of the pulse waveform varies with luminance. FIG. 16A is a block diagram of the luminance adjustment controller 51, and FIG. 16B is an example of the characteristic chart held by the CV value calculation unit 57.

Similar to the case shown in FIGS. 15A and 15B, the pulse waveform is inputted into the luminance adjustment controller 51 and integrated in the integration circuit to obtain the necessary luminance L. This necessary luminance L is analog.

The luminance adjustment controller 51 obtains a CV value (analog value) corresponding to the necessary luminance L according to the characteristic chart shown in FIG. 16B.

Herein, when the input of the voltage changing circuit 58 is analog, the output as the correction value SOP should be analog. However, when the TFT constituting the voltage changing circuit 58 and the TFT constituting the photo sensor 100 have different characteristics to an analog value, matching thereof is required. The above CV value (analog value) is a value to which the matching has been applied, and is outputted as the correction value SOP.

FIGS. 17A and 17B show the case where the detection result of the photo sensor 100 is a DC value varying with luminance in an analog manner. FIG. 17A is a block diagram of the luminance adjustment controller 51, and FIG. 17B is an example of the characteristic chart held by the CV value calculation unit 57.

Similar to the case shown in FIGS. 13A and 13B, a current and a voltage from the photo sensor 100 are inputted into the luminance adjustment controller 51 to provide the necessary luminance L.

The luminance adjustment controller 51 obtains a CV value (analog value) corresponding to the necessary luminance L according to the characteristic chart shown in FIG. 17B, and the correction value SOP which is analog is obtained in the CV value calculation unit 57.

The conversion to match the correction value SOP with the TFT constituting the voltage changing circuit 58 is then carried out, and the analog value obtained by the conversion is outputted as the correction value SOP.

FIGS. 18 to 20 are circuit diagrams showing the voltage changing circuit 58. The voltage changing circuit 58 of this embodiment is provided within the DC/DC converter 56 and supplies the power sources PV and CV of the driving TFT 6 and the organic EL element 7 as shown in FIG. 11.

Specifically, as shown in FIGS. 18 to 20, the voltage changing circuit 58 is a circuit including a series regulator SR provided with a regulator IC 81, switching TFTs 82, and resistors R. The voltage changing circuit 58 is configured in order that each resistor R can be switched on and off depending on the correction value SOP. Herein, the regulator IC 81 outputs a signal ADJ which determines a maximum CV value.

FIG. 18 shows a two-step adjustment circuit, in which one resistor R is connected to the series regulator SR. The resistor R is switched on and off by the switching TFT 82, thus allowing the CV voltage to change in two steps.

The signal inputted into the switching TFT 82 is the correction value SOP outputted from the luminance adjustment controller 51. In the case of the two-step adjustment circuit, the inputted correction value SOP is the correction value SOP (1/0) shown in FIGS. 13A, 14A, and 15A, by which the resistor R is connected or disconnected. The CV value corresponding thereto is applied to the power source CV, and the luminance (the light intensity) of the organic EL elements 7 can be adjusted in two steps.

FIG. 19 is a multi-level adjustment circuit, in which a plurality of resistors R1 and R2 are connected to the series regulator SR. The resistors R1 and R2 are switched on and off by the switching TFTs 82, and the CV voltage can be changed in several steps by combinations of these resistors.

The signal inputted to the each TFT 82 is the correction value SOP (1/0) outputted from the luminance adjustment controller 51 shown in FIGS. 13A, 14A, and 15A. In the case of the multi-step adjustment, the luminance adjustment controller 51 outputs a plurality of correction values SOP1 and SOP2.

As an example, the voltage changing circuit 58 is configured in order that: when the resistors R1 and R2 are off, the luminance can be 80 cd/m²; when the resistors R1 and R2 are on and off, respectively, the luminance can be 150 cd/m²; and when the resistors R1 and R2 are off and on respectively, the luminance can be 250 cd/m² (for those resistance values, R1=R2). As a result of sensing ambient light, suppose the luminance adjustment controller 51 calculates that luminance of 80 cd/m² is required. The luminance adjustment controller 51 then calculates such a CV value that the above luminance can be obtained and further converts the CV value to the correction value SOP, outputting SOP1=0 and SOP2=0. The two resistors of the multi-step adjustment circuit are both disconnected, and the corresponding CV value can be obtained. This CV value is supplied to the power source CV, and the corrected voltage is therefore applied to the organic EL elements 7, the luminance of which is 80 cd/m².

In a similar way, when SOP1=1 and SOP2=0 are inputted, the luminance of the organic EL element 7 is 150 cd/m². When SOP1=1 and SOP2=1 are inputted, the luminance of the organic EL elements 7 is 250 cd/m².

In the drawing, three-step adjustment using two resistors is described. In the case of multi-step adjustment circuit, the CV value can be changed in steps according to the number of the resistors connected. Accordingly, with more resistors connected, finer luminance adjustment can be achieved.

Herein, in the case where the correction value SOP takes two values (1/0), the luminance adjustment controller 51 shown in FIGS. 13A, 14A, and 15A and the voltage changing circuit 58 shown in FIGS. 18 and 19 can be freely combined for each application.

FIG. 20 is another embodiment of the multi-step adjustment circuit, into which the analog correction value SOP outputted from the luminance adjustment controller 51 shown in FIGS. 16A and 17A is inputted.

This multi-step adjustment circuit has the same structure as that shown in FIG. 18, in which one resistor R is connected to a series regulator SR. The resistor R is more gradually switched depending on the analog correction value SOP inputted to the TFT 82. In other words, the CV value is not switched between two values of on and off but can be shifted like a variable resistor. The luminance of the display area 21 can be therefore gradually adjusted.

According to embodiments of the present invention, first, the organic EL display is provided with the photo sensor and the luminance adjustment controller, whereby luminance can be adjusted according to ambient light sensed by the photo sensor. This enables the display area to maintain constant contrast even when a surrounding environment thereof changes. Moreover, the amount of electric current is adjusted according to the ambient light, whereby it is possible to provide the organic EL display which achieves lower power consumption and longer operating life.

Secondly, the data signal outputted to the display area is adjusted by the correction value outputted from the luminance adjustment controller. This enables the display area to maintain constant contrast even when light intensity of the environment thereof varies.

Thirdly, the white reference voltage of the gradation standard voltage circuit is set to be the correction value outputted from the luminance adjustment controller to adjust the data signal, and luminance of the display area can be thereby adjusted. Moreover, in this case, the luminance adjustment can contribute to electric current of power consumption (P=V×I), and therefore the power consumption can be reduced. Furthermore, different gamma characteristics corresponding to ambient light are held, and gamma correction is performed by a gamma characteristic corresponding to the correction value. This enables correction of intermediate gradations between black and white.

Fourthly, setting the white reference voltage of the gradation standard voltage circuit to be the correction value allows the luminance of the display area to be adjusted without reducing the number of gradations. The luminance Lel(black), if enough contrast of the display area is obtained indoors before product shipment or the like, is low enough even in the open air, and changes thereof cannot affect the contrast. On the other hand, an increase in the luminance Lel(white) can increase the contrast. In other words, the white reference voltage is changed to increase the luminance Lel(white) and enables the display area to maintain constant contrast even in the open air with plenty of reflected light.

Fifthly, the voltage applied to the thin film transistor and the EL element is adjusted by the correction value outputted from the luminance adjustment controller. The display area can therefore maintain constant contrast even when the light intensity of its environment varies. Moreover, a value of the power source CV is changed. Accordingly, the luminance adjustment can be directly reflected on the power consumption and, in particular, can contribute to both a voltage and an electric current in power consumption (P=V×I). In the case of using the display device indoors without increasing the luminance, a large effect can be therefore obtained on reduction of power consumption.

Sixthly, the value of the power source CV of the voltage changing circuit is changed by the correction value, and the display device can therefore operate in a region with a large electric current.

Seventhly, the photo sensor is a TFT and can be arranged on the substrate as that of the display area. Accordingly, the photo sensor can sense light intensity equivalent to the ambient light received by the display area. The luminance can be therefore adjusted according to the ambient light intensity in order that the luminance can be increased when it is bright and is reduced when it is dark.

What is claimed is:

1. A display device comprising:
a display area comprising a plurality of pixels arranged on a substrate and displaying an image;
a photosensor provided on the substrate and configured to measure ambient light intensity; and
a luminance adjustment controller outputting a signal to adjust a contrast of the image displayed in the display area based on the measured ambient light intensity.

2. The display device of claim 1, wherein the photosensor comprises a thin film transistor that converts light incident thereon into an electrical signal, and the thin film transistor comprises an insulating film, a gate electrode and a semiconductor layer comprising a channel, a source and a drain.

3. A display device comprising:
a display area comprising a plurality of pixels arranged on a substrate;
a photosensor provided on the substrate and configured to measure ambient light intensity;
a luminance adjustment controller outputting a signal to adjust luminance of the pixels based on the measured ambient light intensity; and
display data correction circuit adjusting image data supplied to the pixels based on the signal outputted from the luminance adjustment circuit.

4. The display device of claim 3, wherein the luminance of the pixels is adjusted so as to maintain a proper contrast of an image displayed in the display area.

5. The display device of claim 3, wherein the display data correction circuit comprises a gradation standard voltage generating circuit that receives the signal outputted from the luminance adjustment circuit as a first reference voltage and divides a potential between the first reference voltage and a second reference voltage to obtain a plurality of gradation display voltages.

6. The display device according to claim 5, wherein the first reference voltage corresponds to a maximum luminance level of the pixels.

7. The display device according to claim 3, wherein each of the pixels comprises an electroluminescent element comprising a light emitting layer disposed between an anode and a cathode and a thin film transistor driving the electroluminescent element.

8. The display device of claim 3, wherein the photosensor comprises a thin film transistor that converts light incident thereon into an electrical signal, and the thin film transistor comprises an insulating film, a gate electrode and a semiconductor layer comprising a channel, a source and a drain.

9. A display device comprising:
a display area comprising a plurality of pixels arranged on a substrate;
an electroluminescent element disposed in each pixel and comprising a light emitting layer disposed between an anode and a cathode;
a thin film transistor disposed in each pixel and driving a corresponding electroluminescent element;
a photosensor provided on the substrate and configured to measure ambient light intensity;
a luminance adjustment controller outputting a signal to adjust luminance of the electroluminescent elements based on the measured ambient light intensity;
a first power source connected with the thin film transistor and supplying a first power source voltage to the thin film transistor;
a second power source connected with the electroluminescent element and supplying a second power source voltage to the electroluminescent element; and
a voltage changing circuit changing a potential between the first and second power sources based on the signal outputted from the luminescent adjustment controller.

10. The display device of claim 9, wherein the luminance of the electroluminescent elements is adjusted so as to maintain a proper contrast of an image displayed in the display area.

11. The display device according to claim 9, wherein the voltage changing circuit changes one of the first and second power source voltages.

12. The display device according to claim 9, wherein the voltage changing circuit comprises voltage variable circuit changing the potential between the first and second power sources.

13. The display device of claim 9, wherein the photosensor comprises a thin film transistor that converts light incident thereon into an electrical signal, and the thin film transistor comprises an insulating film, a gate electrode and a semiconductor layer comprising a channel, a source and a drain.
